(19) United States
(12) Patent Application Publication
(10) Pub. No.: US 2022/0300345 A1
(43) Pub. Date: Sep. 22, 2022

(54) Entity and Method Performed therein for Handling Computational Resources

(71) Applicant: Telefonaktiebolaget LM Ericsson (publ), Stockholm (SE)

(72) Inventors: Joel Patrik Reijonen, Kirkkonummi (FI); Eero Hiltunen, Espoo (FI)

(21) Appl. No.: 17/638,394

(22) PCT Filed: Aug. 26, 2019
(86) PCT No.: PCT/SE2019/050781

§ 371 Date: Feb. 25, 2022

(51) Int. Cl. G06F 9/50; G06K 9/62; G06N 20/00

(52) U.S. Cl. CPC G06F 9/5083; G06F 9/5022; G06F 9/505; G06K 9/6256; G06N 20/00; G06F 2209/5019

(57) ABSTRACT

Embodiments herein relate to e.g. a method performed by an entity in a communication network for providing a service using distributed resources in the communication network. The entity obtains a detected state of computational performance of the service, and determines, based on the obtained detected state, a policy for handling scaling of resources in the communication network. The entity further initiates a scaling of the resources based on the determined policy.

### TECHNICAL FIELD

Embodiments herein relate to an entity and a method performed therein. In particular, embodiments herein relate to handling resources in a communication network.

### BACKGROUND

Cloud computing and processing has become very widely adopted during the past years due to its efficiency, scalability and accessibility. Efficient deployment, configuration and management of increasing amount of deployed applications in cloud environment requires proper usage of orchestration. Container orchestration, in particular, refers to automated deployment, scaling and management of containerized applications that are running in the cloud. Most of the state of the art orchestration systems take advantage in pods, or similar entities, that are the smallest deployable units of computing that are created and managed by the orchestrator. These pods wrap containerized applications and local data storages into an entity that the orchestrator can manage in an automated manner.

To greatly simplify, a computer system comprises processing units, such as central processing units (CPUs), connected to a main memory. The CPU fetches different instructions and data from the main memory. Herein CPU is used to refer to a processing unit or a set of processing units such as a collection of processor cores on the same socket/die. Autoscaling is a process that is used in cloud-computing to adjust allocated resources also referred to as computational resources, such as memory and CPU time, to maintain desired quality of service. Additional resources can be allocated for a limited time and deallocated when they become redundant. In theory, this results to maximal performance with minimal use of computational resources. Therefore, autoscaling is carried out on many levels within cloud infrastructure. For instance, the number of active servers can be adjusted in a server farm, and applications can be moved to larger virtual machines or containers. In addition, autoscaling can operate both vertically and horizontally, which means that allocated computational resources can be adjusted by changing the capacity of a resource, e.g. a processor, or the number of instances of a resource, plurality of processors.

Machine learning as one of the major industry optimization technology, has increased its value by successful attempts to extract hidden information from processed data and increase significantly application optimization window. Machine learning technology is conquering many fields of industry due to ability to efficient processing of the growing amounts of data and bringing additional values on the top. Machine learning enables optimization in wide range of applications especially when the solution algorithm is unknown or it is hard to define. Even though machine learning usage may benefit the overall performance, there is a downside when it comes to the model training that may demand a great amount of computational resources.

Unsupervised learning refers to machine learning which draws conclusions from datasets that consist of input data without labeled outputs. Unsupervised learning algorithms may be utilized for example in clustering analysis and anomaly detection. Cluster analysis is the practice of finding patterns or groupings from the dataset with the help of algorithmic methods. One of the most commonly used clustering algorithm is called k-means clustering, which aims to partition the dataset into k cluster.

Current autoscaling solutions are often rule-based systems which means that autoscaling adjustments are based on human-crafted rules that take into account pre-defined metrics. In practice, CPU utilization is observed and upon it exceeding or falling below a constant threshold—allocated resources are readjusted. This results to two main problems:
suboptimal allocation of resources caused by oscillation and fault measurements
slow response time to increased or decreased volume of work.

These two problems are significant because most public cloud computing services are charged based on used resources. Hence, suboptimal autoscaling may cause additional overhead.

### SUMMARY

An object of embodiments herein is to provide a mechanism that enable usage of a computational resources in an efficient manner.

According to an aspect the object may be achieved by providing a method performed by an entity in a communication network for providing a service using distributed resources in the communication network. The entity obtains a detected state of computational performance of the service, and determines, based on the obtained detected state, a policy for handling scaling of resources in the communication network. The entity then initiates a scaling of the resources based on the determined policy.

According to another aspect the object may be achieved by providing an entity for providing a service using distributed resources in a communication network. The entity is configured to obtain a detected state of computational performance of the service, and to determine, based on the obtained detected state, a policy for handling scaling of resources in the communication network. The entity is further configured to initiate a scaling of the resources based on the determined policy.

It is furthermore provided herein a computer program product comprising instructions, which, when executed on at least one processor, cause the at least one processor to carry out the method above, as performed by the entity. It is additionally provided herein a computer-readable storage medium, having stored thereon a computer program product comprising instructions which, when executed on at least one processor, cause the at least one processor to carry out the method according to the method above, as performed by the entity.

The embodiments herein provide a method that enables efficient and intelligent utilization of autoscaling by taking advantage in cognitive state detection. The proposed method enables the real-time reconfiguration of an autoscaler in order to improve overall system performance continuously. By taking advantage in real-time reconfiguration a more optimized allocation of the resources and faster response time in various volumes of work is provided. Embodiments herein may thus use resources in a more efficient manner e.g. reduce oscillations and less time to autoscale.

### BRIEF DESCRIPTION OF THE DRAWINGS

The embodiments herein will now be described and explained in more detail in relation to the enclosed drawings, in which:

FIG. 1 shows a schematic overview depicting a system according to embodiments herein;

FIG. 2 shows a schematic overview depicting a node according to some embodiments herein;

FIG. 3 is a schematic flowchart depicting a method performed by an entity according to embodiments herein;

FIG. 4 is a schematic flowchart depicting a method for determining state of computational performance according to embodiments herein;

FIG. 5 is a schematic flowchart depicting a method for reconfiguring scaling of resources according to embodiments herein;

FIG. 6 is a schematic flowchart depicting a method for reconfiguring scaling of resources according to embodiments herein;

FIGS. 7A-B show different ways of reconfiguring autoscaler according to embodiments herein; and

FIG. 8 is a block diagram depicting an entity according to embodiments herein.

### DETAILED DESCRIPTION

Traditional Data Center (DC) architecture consists of racks of server blades that are networked together. Each server blade is self-contained with resources such as processors, memory, storage, and input/output (I/O) peripherals. Since the resources that make up the server blade are within the physical confinement of a ‘box’ replacing or augmenting any one of the components in case of failure causes other resources in the server to also be out of use for a period of time. This induces inflexibility in large scale data centers with respect to maintenance and upgrade of resources. When using autoscaling CPU utilization is observed and upon it exceeding or falling below a constant threshold—allocated resources are readjusted.

Embodiments herein provide a manner for cognitive computational state detection in autoscaling cloud systems by utilizing e.g. unsupervised machine learning techniques. It is herein proposed an entity also referred to cognitive agent that handles: 1) cognitive computational state detection and 2) reconfiguration of the autoscaler. The entity may follow weak notion of agency that considers autonomy (no human intervention needed), social ability (ability to communicate with other entites), reactivity (ability to interact with the deployment environment) and pro-activeness (ability to take the initiative action).

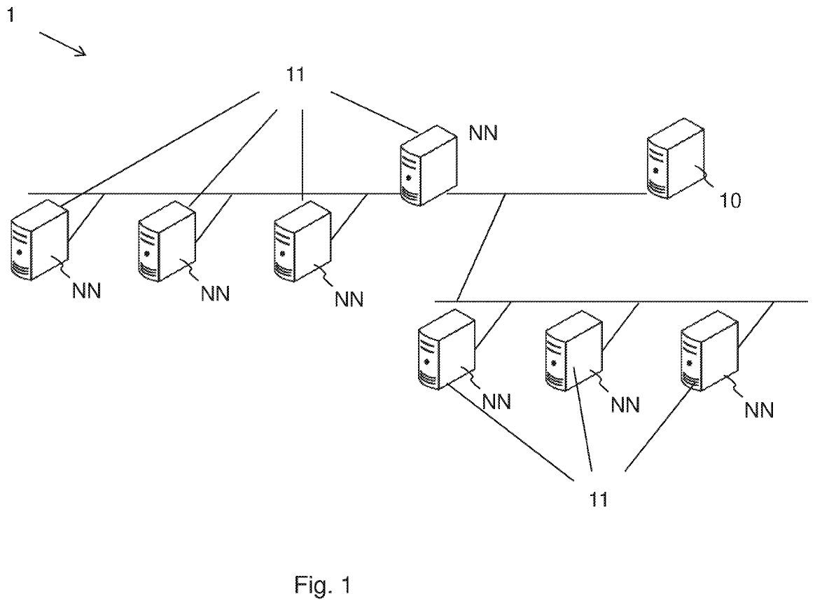

FIG. 1 discloses a communication network 1. The communication network may be a packet switched network comprising a number of network nodes (NN). The communication network may comprise an entity 10 e.g. a hardware entity and/or a distributed entity, wherein computing resources, e.g. processor cores and/or memories of the NNs, are separated. The communication network may comprise a number of communicating entities 11 comprising resources such as one or more processor cores of the NNs, e.g. a pool of processor cores. The entity 10 such as a server or similar provides a service using distributed resources in the communication network 1. The entity 10 obtains, e.g., receives an indication of state or determines, a detected state of computational performance of the service, and determines, based on the obtained detected state, a policy for handling scaling of the resources in the communication network for the service. The entity 10 further initiates a scaling of the resources based on the determined policy.

The entity 10 may obtain e.g. that the state is a first state of computational performance of the service. Such a state may be referred to as cognitive state. The entity 10 may detect the cognitive state in that the entity 10 trains a ML model that is capable to group a set of objects, e.g. tuples of a ML model, in such a way that the objects in the same groups have more similarities in common with each other than those in other groups. This task of grouping is also known as clustering. Clustering analysis is especially effective when the processed data in the ML model is not labelled. The metrics that are gathered from the cloud systems may be inherently unlabeled, and therefore unsupervised machine learning techniques may be considered as a superior alternative. It is herein disclosed a workflow for cognitive state detection that we see as a novel approach that supports autonomy and pro-activeness.

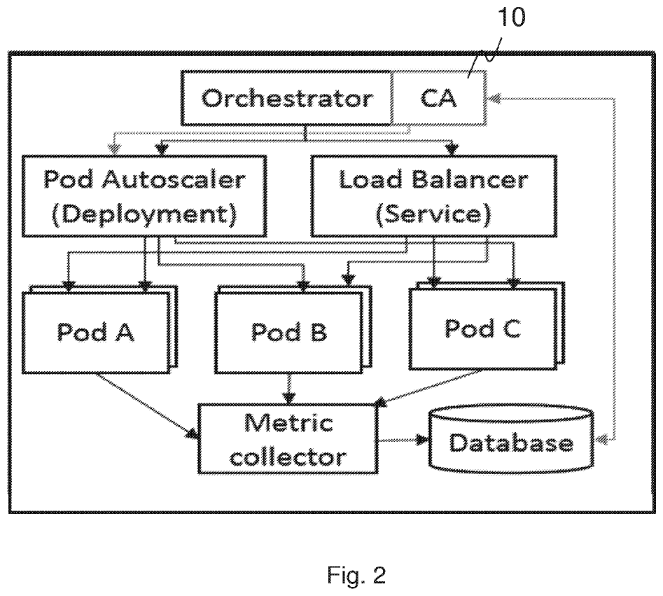

FIG. 2 is a schematic overview depicting examples of functional modules or units of or connected to the entity 10, which also may be referred to as cognitive agent (CA). The entity 10 may be a standalone network node or be part of a node such as a communicating entity 11. By utilizing the cognitive state detection, the entity 10 may learn to detect computational states from the cloud system data and reconfigure the autoscaler accordingly. Arrows to/from the entity 10 represent novel components in an autoscaling cloud systems. An orchestrator (or control plane) schedules, manages and runs control loops to deploy and maintain desired services in a cloud system. A load balancer distributes workloads, e.g. requests for the service, by scheduling workloads between available computing resources such as pods. A pod autoscaler, e.g. horizontal pod autoscaler, implements autoscaling of the resources, such as pods, horizontally or vertically. Horizontal autoscaling refers to the autoscaling of the number of computational resources and vertical autoscaling refers to autoscaling of allocated resources, e.g. CPU, in a computational resource. Pods are the smallest deployable units of computing, and these pods represent computational resources. A metric collector is an external tool for monitoring cloud based metrics. Metric collector gathers the monitored metrics into the database for further processing.

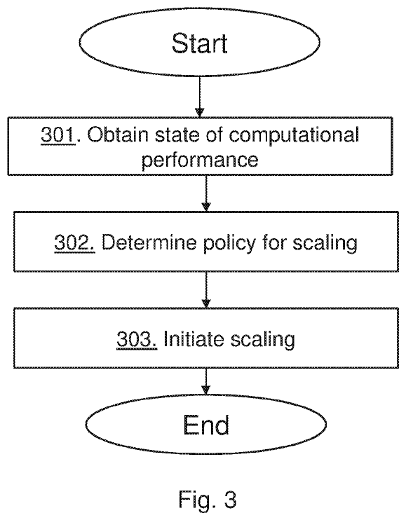

The method actions performed by the entity 10 for providing a service using distributed resources in the communication network, e.g. handling scaling of resources in the communication network 1, according to embodiments will now be described with reference to a flowchart depicted in FIG. 3.

Action 301. The entity obtains the detected state of computational performance of the service. The entity may obtain the state by training or selecting a machine learning model to obtain the detected state from the machine learning model. The entity may train or select the model by clustering objects related to the machine learning model. The entity may obtain the state by using a gradient analysis.

Action 302. The entity 10 determines, based on the obtained detected state, a policy for handling scaling of resources in the communication network. The entity 10 may determine policy upon transition between states of computational performance.

Action 303. The entity 10 initiates a scaling of the resources based on the determined policy.

Embodiments herein may thus use resources in a more efficient manner. Embodiments herein may enable one or more of the following: an enhanced operation of autoscaling within many levels of cloud infrastructure; a detection of computational states that may be hard to detect by cloud system administrator; an optimized use of computational resources e.g. during a state of anomaly; a reduced reaction time to increased or decreased volume of work; a decreased overhead when using public cloud computing services; an improved quality of service; and/or an improved reliability of the service.

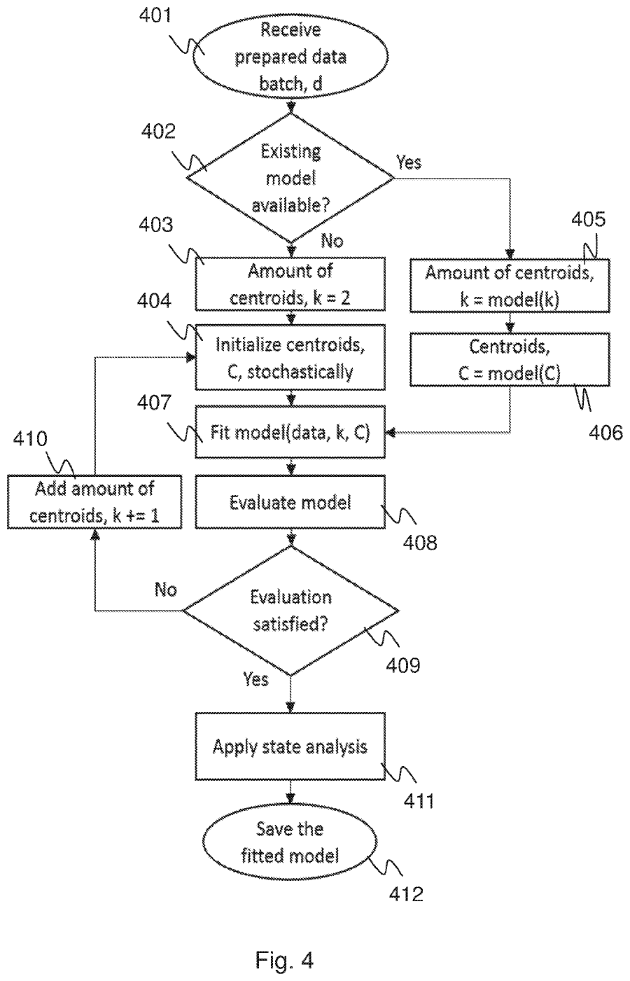

FIG. 4 shows an embodiment wherein the entity 10 may fetch and receive a preprocessed batch of data that the entity 10 either utilizes in training of a new model or in updating an existing model.

Action 401. The entity 10 receives a prepared data batch, d.

Action 402. The entity 10 determines whether an existing model is available for the prepared data batch.

Action 403. In case of training a new model, the entity 10 may initialize the amount of centroids to be two. E.g. a target number k may be determined, which k refers to the number of centroids needed in the dataset. A centroid is the imaginary or real location representing the center of the cluster. Every data point is allocated to each of the clusters through reducing the in-cluster sum of squares. k number of centroids are determined, and then every data point may be allocated to a nearest cluster, while keeping the centroids as small as possible.

Action 404. The values of these centroids may be stochastically determined by the entity 10. The values of centroids are initially determined stochastically since the emphasis in this embodiment is the utilization of machine learning and system awareness that enables personalized model training without introducing biases.

Action 405. Moreover, in the case of updating the ML model, the entity 10 may initialize the amount of centroids.

Action 406. The entity 10 may further determine centroid values based on the information of centroids in the existing model.

Action 407. After the determination of centroids, the entity 10 trains, or fits, an ML model where the centroids are adjusted to be the instances of the most representative values of the group where the objects have more similarities in common than with the objects in the other groups. In this training process, the agent learns to define the most optimal values for the centroids in an iterative manner.

Action 408. After the entity 10 has trained the ML model, the entity 10 may evaluate the model by e.g. defining how well the entity 10 can assign the objects to the groups based on the learned centroids.

Action 409. In this evaluation, the entity 10 may evaluate the distinction of learned groups by evaluating the grouping poorly if the objects are assigned in conflicting and possibly overlapping manner.

Action 410. If the result of evaluation is not satisfying (grouping poorly), the entity 10 may add amount of centroids k+1.

Action 411. If the result of evaluation is satisfying, the entity 10 may conduct state analysis which refers to identification of the characteristics of the detected state. As an example, if the entity 10 finds 5 different computational states, the entity 10 may identify the states in a following way: state 0=stable load, state 1=rapidly increasing load, state 2=increasing load, state 3=constant load, state 4=anomaly. In the state detection, the entity 10 may take advantage e.g. in gradient analysis which is applied to the data that are assigned in the same group. With gradient analysis, the entity 10 may define the characteristics of the state, such as variation, delta, etc. As an example, the entity 10 may take advantage in k-means clustering to find 5 different groups that represent computational states. With gradient analysis, the entity 10 may analyze the characteristics of each computational state in order to identify which of these states represent anomalies, different magnitudes in computational loads, etc.

Action 412. Then, the entity 10 may save the model into the database where the model may be used in reconfiguration of utilized autoscaler.

As stated above the entity 10 determines, based on the obtained detected state, the policy for handling scaling of the resources in the communication network for the service, and further initiates the scaling of the resources based on the determined policy. This may be expressed as adjust autoscaler and apply a reconfiguration of the autoscaler. In reconfiguration of the autoscaler, the entity 10 may utilize the existing ML model that has been trained (fitted) offline. Reconfiguration of the autoscaler may take advantage in real time data stream in order to conduct rapid reconfiguration when the transition of computational state is occurring. Thus, the scaling may be changed upon change of state of computational performance.

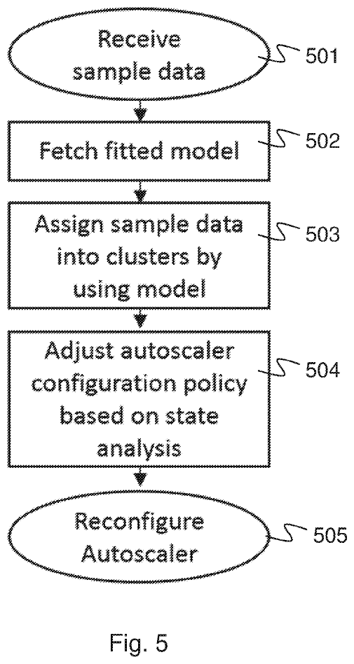

A workflow for reconfiguration of the autoscaler that supports reactivity and pro-activeness is shown in FIG. 5.

Action 501. The entity 10 may receive, or fetch, a sample of the real-time data stream. The sample of the real-time data stream may comprise multiple measurements, e.g. sample1=[1,2,3]. The sample is assigned to a single cluster, e.g. sample1∈cluster 1.

Action 502. The entity 10 may fetch fitted model from database.

Action 503. The entity 10 may utilize an existing model to assign one or more samples into groupings or clusters. The sample sample1 may be assigned to a single cluster e.g. sample1∈cluster 1.

Action 504. After the data sample is assigned, the entity 10 may determine, which of the states detected in FIG. 4, this data sample belongs to. Based on the obtained state, the entity 10 may reconfigure the autoscaler in an appropriate way that supports the efficient utilization of the cloud system resources in an intelligent way.

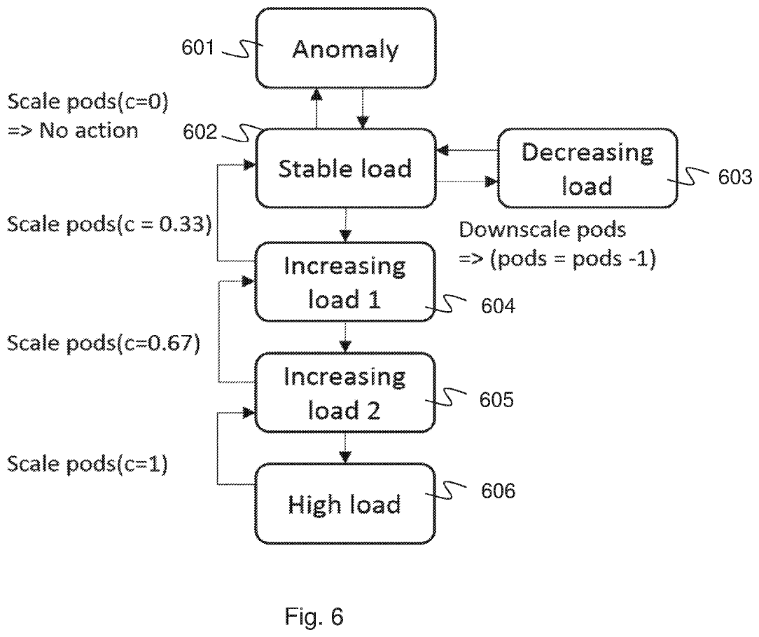

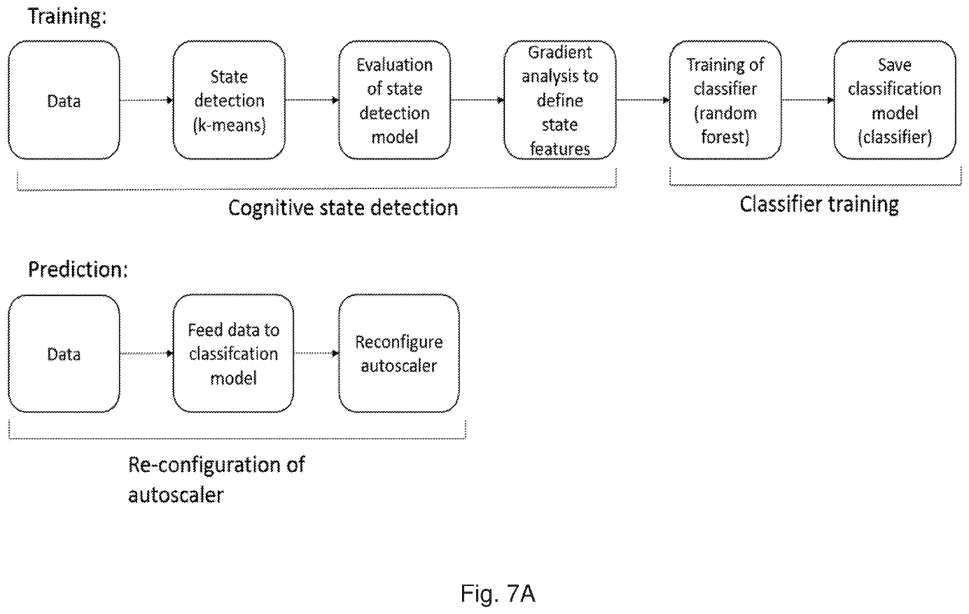

FIG. 6 discloses a manner of utilizing obtained state to adjust scaling.

Action 601. The entity 10 may determine that the state, or the state transited to, is an anomaly state and may not scale number of pods since the detected state is anomaly state.

Action 602. The entity 10 may determine state, or the state transited to, of stable load.

Action 603. The entity 10 may determine state, or the state transited to, of decreased load and then downscale number of pods used.

Action 604. The entity 10 may determine state, or the state transited to, of increased load and then scale up number of pods used e.g. 0.33 pods extra.

Action 605. The entity 10 may determine state, or the state transited to, of even further increased load and then scale up number of pods used e.g. 0.67 pods extra.

Action 606. The entity 10 may determine state, or the state transited to, that the load is high and then scale up to use more pods e.g. c=1.

In a real life example a webserver is considered that is running in an autoscaling cloud system. This is a typical scenario where autoscaling is utilized. In this case, the webserver receives requests from a number of clients, which causes increased workload on the resources such as pods that are serving the application or service. The magnitude of increased workload is defined by the complexity of the webserver's services and the frequency of the requests coming from the clients. As the workload increases—the quality of service potentially decreases, which can create a demand to increase e.g. the number of pods serving the service. A Kubernetes based deployment may be used as an example because it enables autoscaling. The autoscaling component of Kubernetes is called Horizontal Pod Autoscaler (HPA). It is an automatic cloud orchestration component which scales Kubernetes deployments horizontally. The autoscaler may increase or decrease the number of pods, in a deployment, based on CPU utilization in an effort to maintain desirable quality of service with minimal use of resources.

HPA is configured to scale deployment when a pre-determined Pod CPU usage threshold is exceeded. The initial number of pods is increased by 2 replicas after CPU usage exceeds the configured threshold. This autoscaling behavior is optimal because the increased workload is distributed evenly across all the pods by a load balancer, which helps in maintaining quality of service. However, this optimal behavior only occurs when the load increases consistently.

In the case of oscillation and anomalies, HPA does not act in an optimal way—but rather scales the deployment unnecessarily. This means that redundant computational resources are allocated for a relatively long period of time. Short period of increased CPU usage may be applied on the webserver and, as a result, HPA scales the number of pods in an undesirable manner over a time period related to the short period. The reaction time of HPA is slow as it is unable to predict the sudden rises in CPU usage. However, the scaling down also takes by default 5 minutes, which means that computational resources are not only allocated too late but also for too long. Thus, it can be said that reacting to this kind of anomalies is not desirable, and rather, the scaling of application should not happen when the workload only increases for a short time.

In general, state of the art utilization of machine learning in autoscalers regard regression based forecasting of the numeric values of the monitored metrics. In this way, the machine learns to predict numerical variations in monitored metrics e.g. CPU values based on Memory values. The disclosed embodiments differ from these value-based solutions by introducing automated computational state detection which is a differentiation point in existing solutions. The state detection approach is a more holistic approach that supports advanced system awareness instead of numerical predictions. In addition, we utilize these states in reconfiguration of autoscaler whereas state of the art solutions utilize the numerical predictions. Thus, embodiments herein scale computational resources based on state of computational performance. The state of computational performance may be related to load and/or deviation from prior detected state.

Moreover, reinforcement learning approach may also be introduced where the system is rewarded when autoscaler works in an intended way. This reinforcement learning approach is somehow reactive where the operation is taken after an event occurs. The disclosed embodiments differ from reinforcement learning, by introducing detection of computational performance which enables identification of multiple states of computational performance and the states may be predicted in a proactive manner.

It is herein provided a state detection in autoscaling systems to allow utilization of autoscaler that support increased quality of the service, reliability of the service and efficient resource utilization. The entity 10 introduced handles 1) state detection, and 2) reconfiguration of autoscaler. In prior art, the autoscaling solutions are often rule-based systems, which means that autoscaling adjustments are based on human-crafted rules that take into account pre-defined metrics. This leads to a scenario where the autoscaler operates in a static way regardless the varying demand of resources in computational states. Moreover, in cases of anomalies the autoscaler may scale also resources needlessly. Compared to the prior art, it is herein suggested a method that increases the cognitive ability of the autoscaler which increases both intelligent and efficient resource utilization.

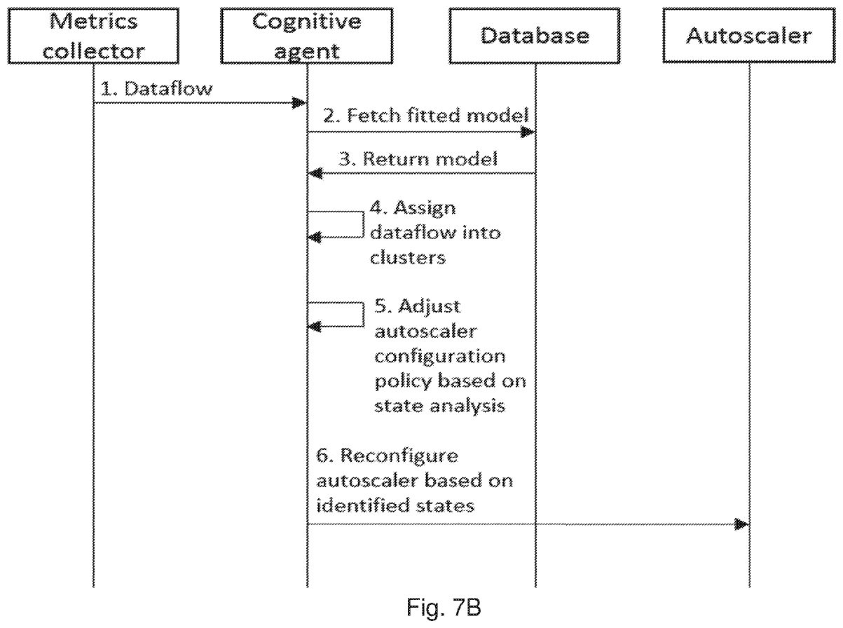

FIG. 7A, shows some examples of machine learning techniques, in brackets, that are applicable according to embodiments herein.

State detection phase:

Data: In both training and prediction, we consider the data to be multi-dimensional input data space that considers e.g. CPU usage, Memory usage, Network transmit and network received.

State detection: In state detection we utilize unsupervised learning techniques where applicable solution could be k-means clustering. In state detection, we identify states from the data by grouping samples with similarities into same state.

Evaluation of state detection model: it may be evaluated how well the data (tuples) that are assigned to different states represent actually the state. As an example, if the detected states are highly overlapping, then we have defined too high number of states.

Gradient analysis to define state features: Automated state analysis may be performed where the ML model maps the states to the behavior that would be expected from the autoscaler. Based on the gradients, the kind of behavior the state represents may be defined and identified.

Classifier training phase:

Training of classifier: a classifier may be trained based on state detection and this trained classifier model is used in real time predictions.

Save classification: The classification model may be saved.

Reconfiguration of autoscaler phase, i.e. prediction phase:

Data: In prediction, data is considered to be multi-dimensional input data space that considers e.g. CPU usage, Memory usage, Network transmit and network received.

Feed data to classification model: the data is fed to the ML model.

Reconfigure autoscaler: the autoscaler may be instructed based on the predicted state and the analysis of the state e.g. 1) if anomaly, do not scale pods, 2) if rapidly increasing load, scale pods with high magnitude.

FIG. 7B is a combined signalling scheme and flowchart according to embodiments herein. The entity 10 is exemplified as a CA in this figure.

Action 1. The CA may fetch and/or receive a sample of the real-time data stream.

Action 2. The CA may fetch fitted model from database.

Action 3. The database may transmit the model back to the CA.

Action 4. The CA may utilize the model to assign these data samples into groupings or clusters.

Action 5. The CA may adjust policy for scaling e.g. autoscaler configuration policy, based on the detected state.

Action 6. Based on the identified state, the entity 10 may reconfigure the autoscaler in an appropriate way that supports the efficient utilization of the cloud system resources in an intelligent way.

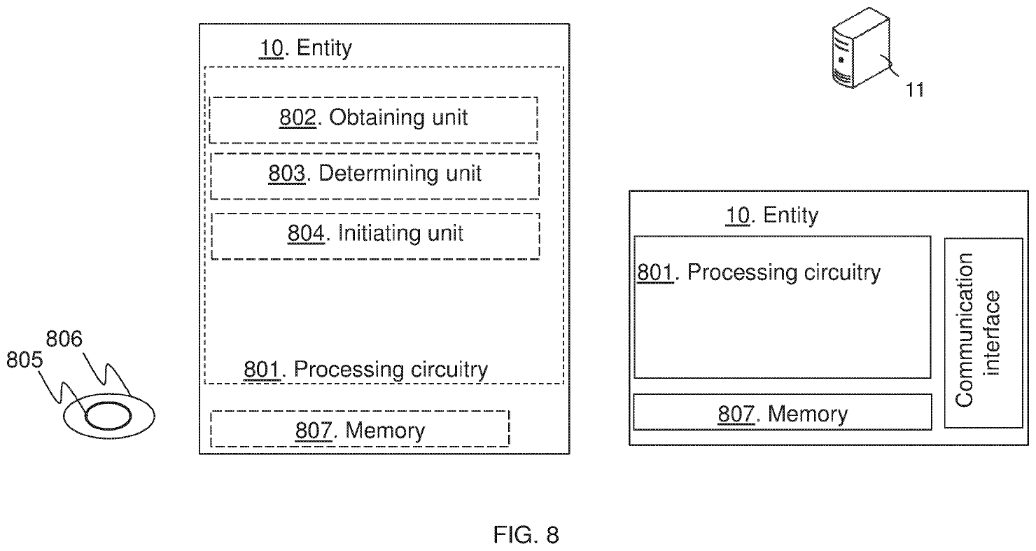

FIG. 8 is a block diagram depicting the entity 10 in two embodiments for providing a service using distributed resources in the communication network. The entity 10 may be operable for allocating resources to service. This may be running somewhere in a cloud and the entity 10 may comprise processing circuitry 801 e.g. one or more processors, configured to perform the methods herein.

The entity 10 may comprise an obtaining unit 802, e.g. a receiver, a transceiver, a processor, or retrieving module. The entity 10, the processing circuitry 801, and/or the obtaining unit 802 is configured to obtain a detected state of computational performance of the service. The entity 10, the processing circuitry 801, and/or the obtaining unit 802 may be configured to train a machine learning model or select the machine learning model to obtain the detected state from the trained model. The entity 10, the processing circuitry 801, and/or the obtaining unit 802 may be configured to cluster objects related to the machine learning model to train or select the machine learning model. The entity 10, the processing circuitry 801, and/or the obtaining unit 802 may be configured to obtain the detected state by using a gradient analysis.

The entity 10 may comprise a determining unit 803, e.g. a processor, or determining module. The entity 10, the processing circuitry 801, and/or the determining unit 803 is configured to determine, based on the obtained detected state, a policy for handling scaling of resources in the communication network. The entity 10, the processing circuitry 801, and/or the determining unit 803 may be configured to determine the policy upon transition between states of computational performance.

The entity 10 may comprise an initiating unit 804, e.g. a processor, or triggering module. The entity 10, the processing circuitry 801, and/or the initiating unit 804 is configured to initiate the scaling of the resources based on the determined policy.

The entity 10 further comprises a memory 807. The memory comprises one or more units to be used to store data on, such as states, thresholds to determine states such as load thresholds, policies, messages comprising triggering index to initiate scaling, applications to perform the methods disclosed herein when being executed, and similar.

The methods according to the embodiments described herein for the entity 10 are respectively implemented by means of e.g. a computer program product 805 or a computer program, comprising instructions, i.e., software code portions, which, when executed on at least one processor, cause the at least one processor to carry out the actions described herein, as performed by the entity 10. The computer program 805 may be stored on a computer-readable storage medium 806, e.g. a universal serial bus (USB) stick, a disc or similar. The computer-readable storage medium 806, having stored thereon the computer program product, may comprise the instructions which, when executed on at least one processor, cause the at least one processor to carry out the actions described herein, as performed by the entity 10. In some embodiments, the computer-readable storage medium 806 may be a non-transitory or a transitory computer-readable storage medium. The entity 10 may comprise a communication interface comprising a transceiver, a receiver, a transmitter, and/or similar.

As will be readily understood by those familiar with communications design, that functions means, units, or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of an intermediate network node, for example.

Alternatively, several of the functional elements of the processing circuitry discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of entities will appreciate the cost, performance, and maintenance trade-offs inherent in these design choices.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1.-12. (canceled)

13. A method performed by an entity in a communication network for providing a service using distributed resources in the communication network, the method comprising:
obtaining a detected state of computational performance of the service;
determining, based on the obtained detected state, a policy for handling scaling of resources in the communication network; and
initiating a scaling of the resources based on the determined policy.

14. The method according to claim 13, wherein obtaining comprises training or selecting a machine learning model to obtain the detected state from the machine learning model.

15. The method according to claim 14, wherein training or selecting comprises clustering objects related to the machine learning model.

16. The method according to claim 13, wherein determining the policy is performed upon transition between states of computational performance.

17. The method according to claim 13, wherein obtaining the detected state comprises using a gradient analysis.

18. An entity for providing a service using distributed resources in a communication network, wherein the entity comprises processing circuitry configured to:
obtain a detected state of computational performance of the service;
determine, based on the obtained detected state, a policy for handling scaling of resources in the communication network; and
initiate a scaling of the resources based on the determined policy.

19. The entity according to claim 18, wherein the processing circuitry is configured to train a machine learning model or select the machine learning model to obtain the detected state from the trained model.

20. The entity according to claim 19, wherein the processing circuitry is configured to cluster objects related to the machine learning model to train or select the machine learning model.

21. The entity according to claim 18, wherein the processing circuitry is configured to determine the policy upon transition between states of computational performance.

22. The entity according to claim 18, wherein the processing circuitry is configured to obtain the detected state by using a gradient analysis.

23. A computer-readable storage medium, having stored thereon a computer program product comprising instructions which, when executed on at least one processor of an entity for providing a service using distributed resources in a communication network, cause the at least one processor to:
obtain a detected state of computational performance of the service;
determine, based on the obtained detected state, a policy for handling scaling of resources in the communication network; and
initiate a scaling of the resources based on the determined policy.
